(19) United States
(12) Patent Application Publication
(10) Pub. No.: US 2012/0019985 A1
(43) Pub. Date: Jan. 26, 2012

(54) ALUMINUM ELECTROLYTE CAPACITOR

(75) Inventors: CHUN-KONG CHAN, TAIPEI COUNTY (TW); CHI-CHING CHEN, TAIPEI COUNTY (TW)

(73) Assignee: LIEN CHANG ELECTRONIC ENTERPRISE CO., LTD., TAIPEI COUNTY (TW)

(21) Appl. No.: 12/839,596

(22) Filed: Jul. 20, 2010

(51) Int. Cl. H01G 9/045

(52) U.S. Cl. 361/509

(57) ABSTRACT

An aluminum electrolytic capacitor includes a main body, two electric leads, and a metal set plate. The main body has a base and a plastic insulating film. The electric leads are located at one end of the base. The metal set plate is located at opposite end, with a connecting portion and a soldering portion. The connecting portion is located at the surface of the other end of the base opposite of the two electric leads. The soldering portion extends outside of the main body. The plastic insulating film wraps around the main body and the outer edge of the connecting portion. Thereby, the metal set plate is secured firmly with the main body. The soldering portion of the metal set plate is soldered onto the printed circuit board, allowing the aluminum electrolytic capacitor to be firmly attached to the printed circuit board.

### BACKGROUND OF THE INVENTION

1. Field of the Invention

The present invention relates to an electrolytic capacitor; in particular, to an aluminum electrolytic capacitor that can be firmly fastened on the printed circuit board.

2. Description of Related Art

Capacitors are used for storing electric charge, AC filtering, bypass circuit, cutting off or blocking DC voltage, moderating output voltage, and providing oscillation. Different kinds of capacitors have different characteristics. Therefore, the functions and application fields are also different. Because the aluminum electrolytic capacitor has higher static electricity capacity and the manufacturing cost is lower, the device is applicable in various fields, namely communication electronics and electric products such as power supplies, mother boards, surveillance cameras, and audio players.

Of the prior art, when the aluminum electrolytic capacitor is installed on the printed circuit board, the two electric leads of the aluminum electrolytic capacitor are plugged into slotted holes on the printed circuit board. Next, the assembly is sent into a furnace for tin soldering. To prevent the aluminum electrolytic capacitor from being damaged due to external force or dropped from the printed circuit board, the workers need to spot glue between the aluminum electrolytic capacitor and the printed circuit board. Such process has several drawbacks. First, not all aluminum electrolytic capacitors are assured in receiving spot gluing. Second, the glue may peel off after a period of time. Thereby, the electrolytic capacitor cannot be assured to stay firmly on the printed circuit board. In addition, manpower is wasted in performing spot gluing, which increases the manufacturing time and cost.

### SUMMARY OF THE INVENTION

The object of the present invention is to provide an aluminum electrolytic capacitor with a metal set plate, which can be soldered onto the printed circuit board. The solution assures the aluminum electrolytic capacitor stays firmly on the printed circuit board.

In order to achieve the aforementioned objects, according to an embodiment of the present invention, an aluminum electrolytic capacitor is provided. The aluminum electrolytic capacitor comprises a main body with a base and a plastic insulating film, two electric leads at one side of the base, and a metal set plate at the other side of the base, opposite of the two electric leads. The metal set plate has a connecting portion to the base, and a soldering portion that extend outward from the main body. The plastic insulating film of the main body wraps around the base and the outer edge of the connecting portion. Thereby, the metal set plate is securely connected to the main body.

The present invention has the following advantages. For the aluminum electrolytic capacitor, the metal set plate's soldering portion can be soldered directly onto the printed circuit board. Thereby, the aluminum electrolytic capacitor is secured more firmly on the printed circuit board. When under vibration or any external force, the aluminum electrolytic capacitor is not easily damaged or detached from the printed circuit board. Furthermore, the present invention only need soldering one time, to solder the electric leads and the soldering portion of the metal set plate onto the printed circuit board. No manpower is needed to perform the glue-spotting process. Thereby, the manufacturing process is simplified, and the manufacturing time and cost is reduced.

In order to further the understanding regarding the present invention, the following embodiments are provided along with illustrations to facilitate the disclosure of the present invention.

### BRIEF DESCRIPTION OF THE DRAWINGS

FIG. 1 shows an exploded perspective view of the aluminum electrolytic capacitor according to an embodiment of the present invention;

FIG. 2 shows another exploded perspective view of the aluminum electrolytic capacitor according to an embodiment of the present invention;

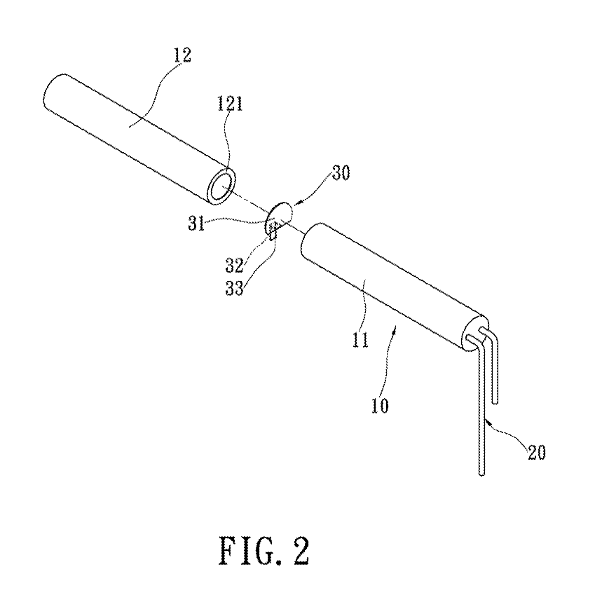

FIG. 3 shows an assembly perspective view of the aluminum electrolytic capacitor according to an embodiment of the present invention; and

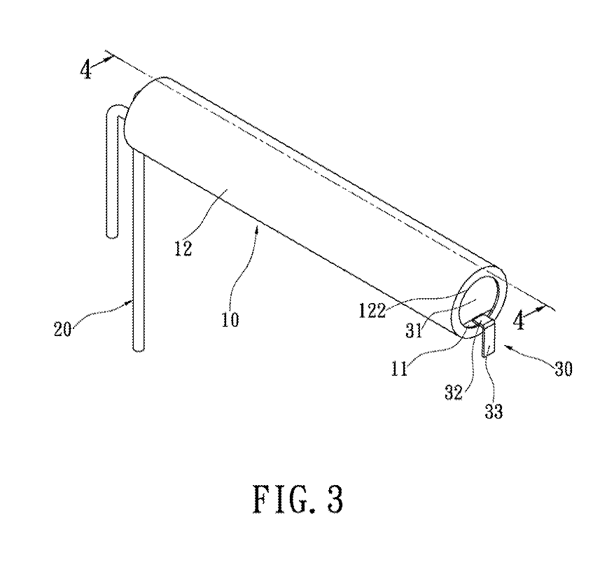

FIG. 4 shows a cross-sectional view of the cross-section 4-4 in FIG. 3.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

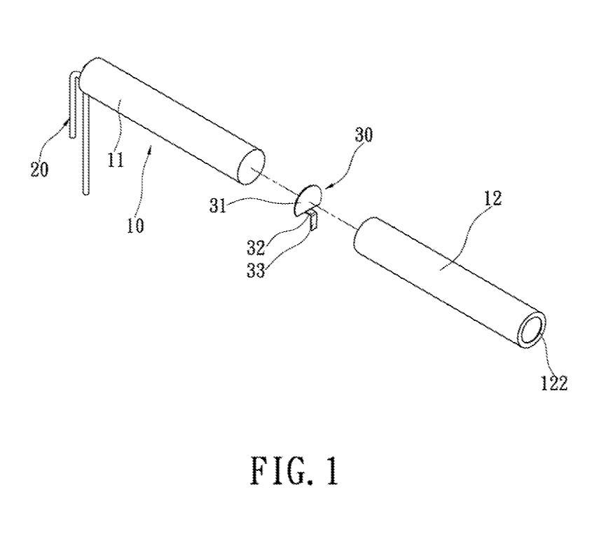

The present invention provides an aluminum electrolytic capacitor (EC capacitor, or EC CAP). Reference is made to FIGS. 1˜3. The aluminum electrolytic capacitor includes a main body 10, two electric leads 20, and a metal set plate 30.

The capacitor's main body 10 has a base 11 and a plastic insulating film 12. The base 11 is a long cylindrical body that extends in the horizontal direction. The plastic insulating film 12 is made of insulating material and wraps around the base 11. The round external surface of the plastic insulating film 12 can be printed with the related texts, such as the capacitance rating, specifications, and the type of the aluminum electrolytic capacitor.

Of the main body 10, the two electric leads 20 are located at one end of the base 11 and electrically connected to base 11. The two electric leads 20 have different polarities, and both lengths can be identical or different. To connect electrically, the two electric leads 20 are used to plug into the slotted holes (not shown in the figure) of a printed circuit board.

Of the main body 10, the metal set plate 30 is located at the other end of base 11 opposite of the two electric leads 20. The metal set plate 30 has a connecting portion 31 and a soldering portion 33. Of the main body 10, the connecting portion 31 is located at the face of the other end of base 11 opposite of the two electric leads 20. The connecting portion 31 is flat and has a semi-circular shape, with the upper portion being circular and aligns exactly to the outer edge of base 11. The soldering portion 33 extends outward from the main body 10. The material of the metal set plate 30 is not limited to a specific type. In one preferred embodiment, the metal set plate 30 is made of tinplate.

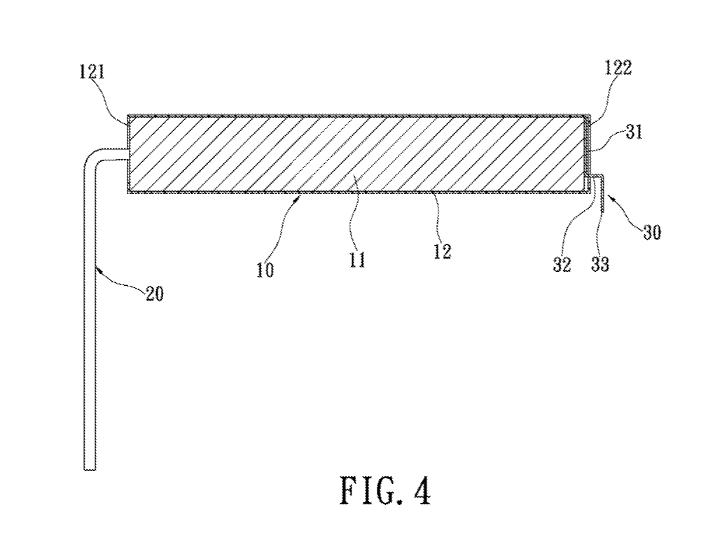

Of the main body 10, the plastic insulating film 12 wraps around the base 11 and covers the outer edge of the connecting portion 31 of the metal set plate 30 (referring to FIG. 4). Thereby, the metal set plate 30 is secured to the main body 10.

When setting the aluminum electrolytic capacitor onto the printed circuit board, the bottom surface of the main body 10 faces the top surface of the printed circuit board. The two electric leads 20 and the soldering portion 33 of the metal set plate 30 are plugged into the respective slots on the printed circuit board. Next, the print circuit board and the aluminum electrolytic capacitor are sent into the tin soldering furnace, where the two electric leads 20 and the soldering portion 33 of the metal set plate 30 are soldered onto the printed circuit board. Thereby, the aluminum electrolytic capacitor is firmly secured.

Reference is made to FIGS. 1˜4. The metal set plate 30 further includes an extension 32. The extension 32 extends off the connecting portion 31 and away from the main body 10. The soldering portion 33 extends downward from the end of the extension 32 and reaches outwardly from the bottom surface of the main body 10.

In this embodiment, the extension 32 extends horizontally off the bottom edge of the connecting portion 31 and axially away from the main body 10, but not limited to above. The width of the extension 32 is the same as the soldering portion 33, with both widths being smaller than the width of the connecting portion 31, but not limited to above. For design purpose, the extension 32 must be long enough to offset the soldering portion 33 a minimum of 2 mm axially away from the main body 10. The specification is needed to meet the safety requirement.

At the location of the two electric leads 20, the plastic insulating film 12 has a first opening 121. At the location of the extension 32 of the metal set plate 30, the plastic insulating film 12 has a second opening 122. The two electric leads 20 penetrates through the first opening 121, and the extension 32 of the metal set plate 30 penetrates through the second opening 122.

In addition to soldering the two electric leads onto the printed circuit board, the present invention also includes a metal set plate where the soldering portion is soldered onto the printed circuit board. Thereby, the aluminum electrolytic capacitor is secured more firmly. Even under vibration and external forces, the aluminum electrolytic capacitor is not easily damaged or slips off from the printed circuit board.

Furthermore, the present invention only need soldering one time, to solder the electric leads and the soldering portion of the metal set plate onto the printed circuit board. No manpower is needed to perform the glue-spotting process. Thereby, the manufacturing process is simplified, and the manufacturing time and cost is reduced.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims. icm What is claimed is:

1. An aluminum electrolytic capacitor, comprising:
a main body having a base and a plastic insulating film;
two electric leads located at one end of the base of the main body; and
a metal set plate located at another end of the base of the main body opposite of the two electric leads, wherein the metal set plate has a connecting portion located at the surface of the other end of the base opposite of the two electric leads and a soldering portion off the main body, the plastic insulating film wraps around the base and the outer edge of the connecting portion;
thereby, the metal set plate is secured onto the main body.

2. The aluminum electrolytic capacitor according to claim 1, wherein the metal set plate further comprises an extension extended off the connecting portion and away from the main body, and the soldering portion that extends downward from the end of the extension reaching outwardly with respect to the bottom surface of the main body.

3. The aluminum electrolytic capacitor according to claim 2, wherein the extension of the metal set plate extends horizontally off the bottom edge of the connecting portion and axially away from the main body.

4. The aluminum electrolytic capacitor according to claim 3, wherein the location of the plastic insulating film that corresponds to the two electric leads has a first opening, and the location of the plastic insulating film that corresponds to the extension of the metal set plate has a second opening, where the two electric leads penetrate through the first opening and the extension of the metal set plate penetrates through the second opening.

5. The aluminum electrolytic capacitor according to claim 4, wherein the base of the main body is cylindrical shaped that extends in a horizontal direction.

6. The aluminum electrolytic capacitor according to claim 1, wherein the metal set plate is made of tinplate.
